(19) United States
(12) Patent Application Publication
(10) Pub. No.: US 2024/0130376 A1
(43) Pub. Date: Apr. 25, 2024

(54) CONVEYOR OVEN

(71) Applicant: THE MIDDLEBY CORPORATION, Elgin, IL (US)

(72) Inventors: Christine S. Laub, Roselle, IL (US); Joseph K. Miko, Lake in the Hills, IL (US); Theodore J. Chmiola, Roscoe, IL (US); William S. Schjerven, SR., Schaumburg, IL (US); Kenneth A. Christensen, Geneva, IL (US)

(21) Appl. No.: 18/048,322

(22) Filed: Oct. 19, 2022

(51) Int. Cl. A21B 1/48; F24C 15/00; F24C 15/08; F24C 15/14

(52) U.S. Cl. CPC A21B 1/48; F24C 15/007; F24C 15/08; F24C 15/14

(57) ABSTRACT

A conveyor oven for cooking food includes an oven housing defining an oven chamber in which the food is cooked. A conveyor is operable to convey the food through the oven chamber. An opening is defined in an end of the oven chamber, a portion of the conveyor extending through a first portion of the opening. A second portion of the opening below the conveyor is closed by a removable end plug. The removable end plug is configured to pivot into a closed position while an upper edge of the removable end plug is received in a pocket formed at the end of the oven chamber by the oven housing and/or at least one stationary portion of the conveyor.

### BACKGROUND

Conveyor ovens are widely used for cooking pizzas and a wide variety of other food products. Examples of such ovens are shown, for example, in U.S. Pat. Nos. 5,277,105, 6,481,433 and 6,655,373, as well as U.S. Pat. Nos. 8,281,779, 8,087,407, and 9,585,401.

Conveyor ovens are typically large metallic housings with a heated tunnel extending through a cooking chamber and a conveyor running through the tunnel. In many cases, such conveyor ovens are either 70 or 55 inches long, although they may be constructed in any other suitable size. The conveyor transports food products through the heated oven tunnel at a speed which cooks food products during their transit through the tunnel. Conveyor ovens typically include a heat delivery system including one or more blowers which supply heat to the tunnel through passageways leading to metal fingers opening into the oven tunnel. Such metal fingers are often located above and below the conveyor. The metal fingers act as airflow channels that deliver streams of hot air which impinge upon the surfaces of the food products passing through the tunnel on the conveyor. In modern conveyor ovens, a microprocessor-driven control panel generally enables the user to regulate heat delivery (e.g., to control the temperature within the oven, the heat output of the heat delivery system, and the like), the speed of the conveyor, and other oven functions to properly cook food product being transported through the oven.

Conveyor ovens are typically used in restaurant kitchens and commercial food manufacturing facilities. Typically, they are kept running for extended periods of time, including periods when food products are not being cooked. Since the inlet and outlet ends of the oven tunnel are open, heat and noise are continuously escaping from the conveyor oven tunnel into the surrounding environment. The open areas at the inlet and outlet ends are limited by end plates or end plugs that close off most of the open area at the ends of the oven, leaving the necessary open space for the conveyor and the food carried thereby. The end plates are removable from the oven housing to allow access to the oven, for example, for cleaning operations or maintenance. However, as described below, the end plates can be at least partially retained in place on the oven housing by the conveyor, and movement and/or partial disassembly of the conveyor may therefore be required to remove/install the end plates.

FIGS. 1-3 illustrate a conventional conveyor oven having a housing 112 defining an oven chamber through which the conveyor 122 extends. At the longitudinal ends of the oven, the conveyor 122 projects out of the housing 112. An opening is provided at each longitudinal end of the housing 112 to accommodate the conveyor 122 and food items positioned thereon. The remaining area at each longitudinal end is closed off by an upper end plug 164 and a lower end plug 168 to minimize heat loss to the environment. The lower end plug 168 generally fills the vertical space between the bottom of the conveyor 112 and the bottom wall 146 of the oven housing 112. An upper edge 180 of the lower end plug 168 is received and retained in a pocket 184 when the end plug 168 is in its closed position as shown in FIG. 3. The end plug 168 has a thickness to provide thermal insulation, and the thickness is generally uniform from the upper edge 180 down to the bottom wall 146 at a given cross-section along the width. Regardless of orientation, the end plug 168 cannot freely be assembled to or removed from the closed position without moving the frame 134 of the conveyor 122. Thus, end plug removal/re-installation for routine maintenance can require loosening or removing some or all fasteners between the conveyor frame 134 and the housing 112, loosening or removing at least a portion of the drive assembly that drives the movable track of the conveyor 122, or loosening or removing the movable track.

### SUMMARY

In one aspect, the invention provides a conveyor oven for cooking food. The conveyor oven includes an oven housing defining an oven chamber in which the food is cooked. A conveyor is operable to convey the food through the oven chamber. An opening is defined in an end of the oven chamber, a portion of the conveyor extending through a first portion of the opening. A second portion of the opening below the conveyor is closed by a removable end plug. The removable end plug is configured to pivot into a closed position while an upper edge of the removable end plug is received in a pocket formed at the end of the oven chamber by the oven housing and/or at least one stationary portion of the conveyor.

In another aspect, the invention provides a conveyor oven for cooking food. The conveyor oven includes an oven housing defining an oven chamber in which the food is cooked. A conveyor is operable to convey the food through the oven chamber, the conveyor including a frame and a track movable with respect to the frame. An opening is defined in an end of the oven chamber, a projecting portion of the conveyor extending out of the oven chamber through a first portion of the opening. A second portion of the opening below the conveyor is closed by a removable end plug. In a closed position of the removable end plug, an upper edge of the removable end plug is at least partially retained by a portion of the conveyor frame extending along the projecting portion of the conveyor. When the removable end plug is in the closed position, a chamfer surface on a lower-inner corner of the removable end plug is received within the oven chamber adjacent a bottom wall of the oven housing.

In yet another aspect, the invention provides a method of assembling a conveyor oven including an oven housing having an oven chamber in which food is cooked and a conveyor that extends through the oven chamber. The method includes inserting an upper edge of a removable end plug into a pocket formed by the oven housing and a frame of the conveyor. The end plug is moved into a closed position whereby at least a portion of a lower edge of the end plug is received inside the oven chamber along a bottom wall of the oven housing. Contact that occurs between the lower edge of the end plug and the bottom wall of the oven housing during the movement of the end plug into the closed position cams the end plug further into the pocket.

### BRIEF DESCRIPTION OF THE DRAWINGS

The aspects and features of various exemplary embodiments will be more apparent from the description of those exemplary embodiments taken with reference to the accompanying drawings.

FIG. 1 is a front perspective view of a conveyor oven according to a conventional design.

FIG. 2 is a detail view of an end of the conveyor oven shown in FIG. 1, including a lower end plug.

FIG. 3 is a front elevation view of the end of the conveyor oven of FIG. 1 with the front wall of the oven housing removed.

FIG. 4 is a front elevation view of a conveyor according to an exemplary embodiment of the present disclosure.

FIG. 5 is a front perspective view of the conveyor oven of FIG. 4. The front wall of the oven housing is removed to reveal the oven chamber and full conveyor.

FIG. 5A is a detail view of a first end of the oven chamber as shown in FIG. 5, including a lower end plug according to an exemplary embodiment of the present disclosure.

FIG. 5B is a detail view of a second end of the oven chamber as shown in FIG. 5, including another lower end plug.

FIG. 6 is an end view of one of the lower end plugs according to an exemplary embodiment of the present disclosure of the conveyor oven of FIG. 4.

FIG. 7A is a perspective view of an initial orientation of the lower end plug shown in FIG. 5B and an initial method step for installation to the oven housing.

FIG. 7B is a perspective view of an intermediate orientation of the lower end plug shown in FIG. 7A and an intermediate method step for installation to the oven housing.

FIG. 7C is a perspective view showing the lower end plug in its closed position following the installation steps shown in FIGS. 7A and 7B.

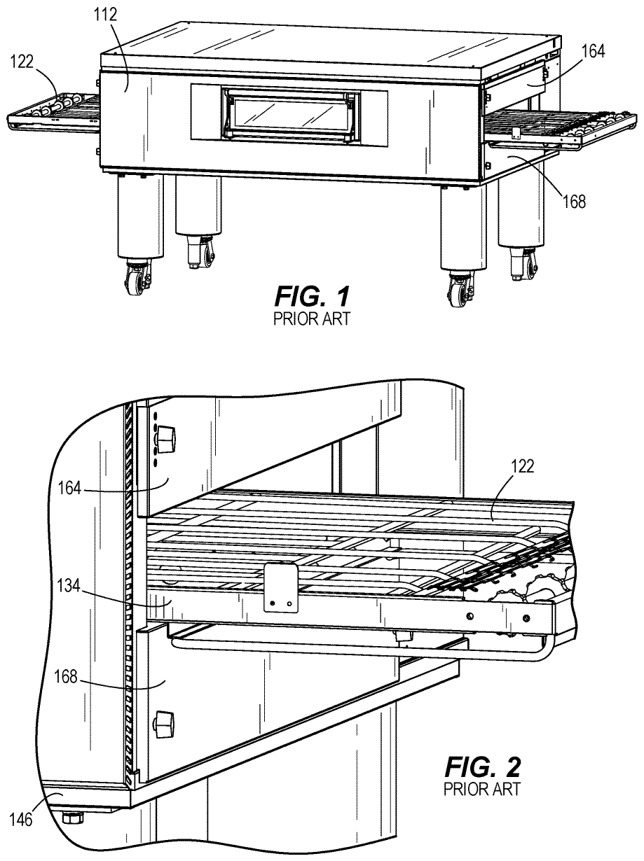

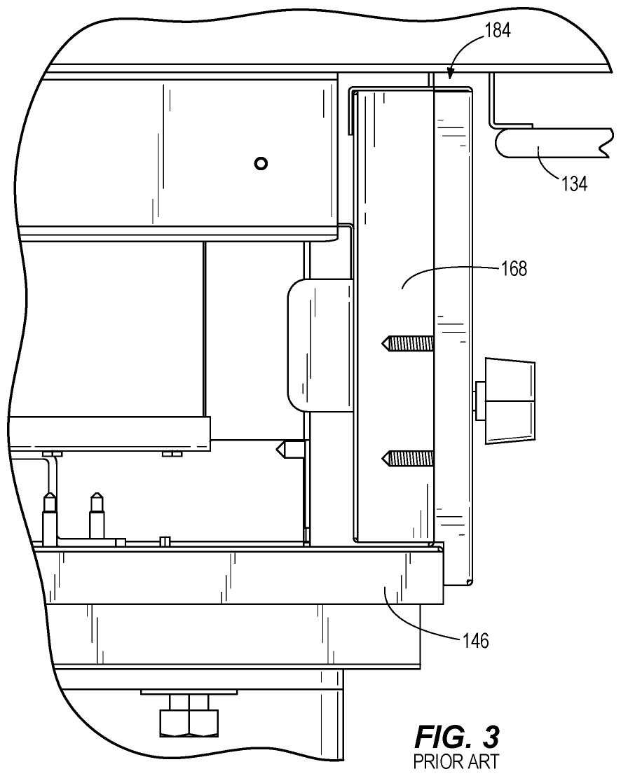

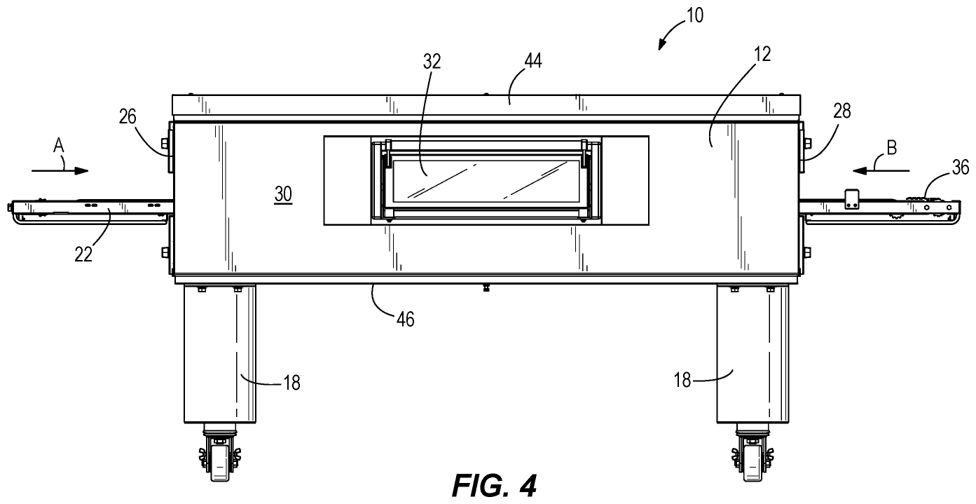

### DETAILED DESCRIPTION

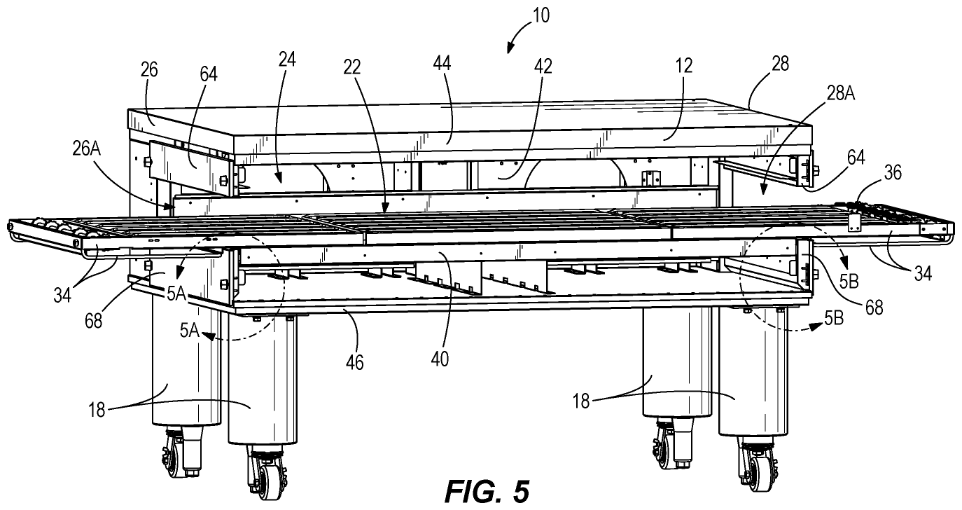

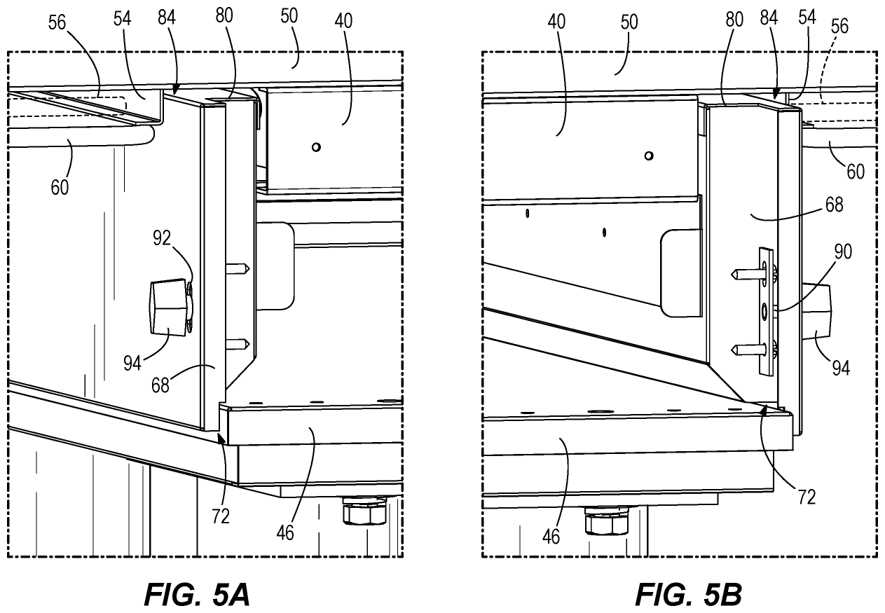

FIGS. 4-6 illustrate a conveyor oven 10 having an oven housing 12, and one or more leg assemblies 18 that extend from the bottom of the oven housing 12. Although certain features of the conveyor oven 10 are disclosed explicitly herein, the oven 10 can incorporate other features including for example those disclosed in Applicant's prior U.S. Patent Applications, including U.S. Patent Application Publication No. 2010/0058936 and/or U.S. Patent Application Publication No. 2020/0037616, the entire contents of both of which are incorporated by reference herein. The oven housing 12 can be box-shaped in some constructions, as shown. The oven housing 12 defines an internal oven chamber 24. The oven chamber 24 is heated (e.g., by an integrated or connected heat source, such as a burner(s)) and forms a tunnel between a first end 26 and a second end 28 of the oven 10. A conveyor 22 runs through the oven chamber 24, including the open tunnel (FIG. 5) thereof. A raw food product can be placed on the conveyor 22 at the first end 26 and transported through the oven 10 by the motorized (e.g., chain-driven) conveyor 22 to exit at the second end 28 as a cooked food product. A front wall 30 of the oven housing 12 can include a viewing window 32, which is optionally incorporated into a hinged door that provides access to the oven chamber 24. In some constructions, the oven can include a door without a window. The controlled cooking operation of the oven 10 can include any or all of the features of Applicant's prior U.S. Pat. No. 11,369,117, the entire contents of which are incorporated by reference herein.

The conveyor 22 has a width generally corresponding to the width of the heated tunnel portion of the oven chamber 24 and is designed to travel in a first direction A, from left oven end 26 toward right oven end 28, or alternatively in the opposite direction B, from right oven end 28 toward left oven end 26. Thus, oven ends 26 and 28 may serve respectively as the inlet and outlet of an oven with a rightwardly moving conveyor 22 or as the outlet and inlet of an oven with a leftwardly moving conveyor 22. It will be understood that the conveyor 22 is an assembly, including a stationary frame 34 and a movable belt or chain, referred to herein as the track 36. The track 36, a small portion of which is illustrated in FIG. 4, moves along an endless loop path, the upper length of which is used to transport the food. As shown in FIGS. 4 and 5, the conveyor 22, including portions of the frame 34 and the track 36, extends outside of the oven housing 12 on at least one end of the oven housing 12 (e.g., both ends 26, 28, through respective openings 26A, 28A in the longitudinal ends of the oven housing 12). A drive mechanism including one or more motors and a plurality of toothed drive wheels (e.g., chain sprockets) can be provided along a portion of the conveyor 22, for example along one lateral edge of the conveyor 22 that is positioned toward the rear of the oven 10. The drive mechanism operates in accordance with conventional techniques as would be understood by one of ordinary skill in the art to drive the conveyor track 36 at a fixed or variable speed with respect to the frame 34 and the oven housing 12 so that food products on the conveyor 22 are transported through the heated tunnel 24 to be cooked.

Normally, only one conveyor 22 is used, as shown. Certain specialized applications, however, may make two or more conveyors a preferable design. For example, a first conveyor may begin at left oven end 26 and travel at one speed to the center or other location of the oven 10, while a second conveyor beginning at such a location and ending at the right oven end 28 may travel at a different speed. Alternatively, conveyors that are split longitudinally may be used, so that one conveyor carries a product in direction A, while the other conveyor carries a product in direction B, or so that two side-by-side conveyors carry product in parallel paths and in the same direction (A or B) through the oven 20. This enables one product to travel on the conveyor 22 at one speed to cook one kind of product and the other conveyor to travel on the other conveyor at a different speed to cook another kind of product. In addition, three or more side-by-side conveyors can carry product in parallel paths through the oven 10.

Along the front wall 30, the conveyor frame 34 is supported by and optionally secured to a support member 40, for example a channel or beam. The support member 40 is shown in FIG. 5 with the front wall 30 otherwise removed in this view. As illustrated, the support member 40 can be a longitudinally extending member secured on an interior side of the front wall 30 at a height suitable for supporting the lower side of the conveyor frame 34 at the operational position of the conveyor 22. As such, the support member 40 functions to position the conveyor 22 with respect to the oven housing 12. The support member 40 can extend a full length of the front wall 30, or a majority thereof. The front wall 30 is one of the outer walls of the oven housing 12, along with a rear wall 42, a top wall 44, and a bottom wall 46, all of which are longitudinally extending, parallel to the conveyor 22. The oven 10 also includes end walls, which are described separately below. Although not shown in detail, the rear wall 42 can include a support member similar to the support member 40 for supporting the rear edge of the conveyor 22 at the same height as the front edge shown in FIG. 5. In addition to supporting the conveyor 22, the support member(s) 40 can support lower hot air delivery plates or “fingers.”

The conveyor frame 34 can be provided in sections, including an end section that extends through and spans the opening 26A and another end section that extends through and spans the opening 28A. Each of these conveyor frame sections can have similar features, as evidenced by FIG. 5 and the detail views of FIGS. 5A and 5B. Although not required in all constructions, the respective end sections of the conveyor frame 34 can be mirror images of each other. Each of the conveyor frame end sections includes a weldment of several metal pieces in the illustrated construction. The weldment includes a longitudinally extending perimeter frame element 50 that is configured to rest upon an upper surface of the support member 40 of the front wall 30. The conveyor frame 34 may be unsecured (e.g., no welding or fasteners) and freely resting upon the support member 40 in slidable relationship therewith, as the conveyor 22 is configured to be removable from the oven chamber 24. Each weldment further includes a downwardly depending member or channel 54 that extends below the perimeter frame element 50 on the exterior of the oven housing 12 adjacent the opening 26A or 28A. The channel 54 can have both a stop (e.g., vertical component) and a ledge (e.g., horizontal component). The vertical component or stop limits the movement of the conveyor 22 with respect to the housing 12 (e.g., limits the insertion depth by interference that prevents the channel 54 from passing into the opening 26A or 28A). The horizontal component or ledge of the channel 54 can extend outward away from the oven housing 12 to support a crumb pan 56 (shown in broken lines in FIGS. 5A and 5B). Each weldment can have an additional channel with a ledge at the distal end of the weldment for supporting an opposite end of the crumb pan 56.

With continued reference to FIGS. 5A and 5B, each of the conveyor frame end section weldments further includes one or more skid bars 60. The skid bars 60 can be rounded in cross-section. The skid bars 60 can be shaped to depend downwardly from the perimeter frame element 50 and to run longitudinally along the perimeter frame element 50. For example, the skid bars 60 can extend along all or a majority of the exposed length of the perimeter frame element 50, from a distal end to the channel 54. The skid bars 60 can be connected (e.g., welded) directly or indirectly to the perimeter frame element 50. At their proximal ends, adjacent the ends of the oven housing, the skid bars 60 can be connected to the perimeter frame element 50 through the respective channels 54. Each conveyor frame end section can include skid bars 60 along both lateral sides. During assembly or removal of the (partially or fully assembled) conveyor 22, the skid bars 60 engage with structures within the oven chamber 24. In particular, the skid bars 60 can engage with and slide upon the support member 40 of the front wall 30 and a similar support member of the rear wall 42. Sliding the conveyor 22 by its skid bars 60 avoids cantilevering the entire conveyor 22 during assembly/removal and maintains the conveyor 22 at its proper operational height spaced above the bottom wall 46.

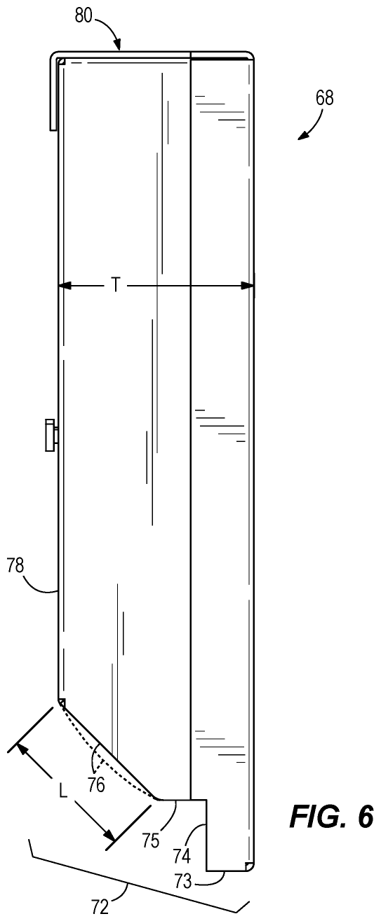

The longitudinal ends of the oven housing 12 are partially closed by a plurality of end plugs or end cover plates 64, 68 that establish the vertical limits of the openings 26A, 28A. The end plugs 64, 68 can be configured as removable exterior walls that are retained by limited fasteners (e.g., quick-release fasteners) to enable simple and quick removal that is not destructive to the oven housing 12. Each end plug 64, 68 closes off a portion of the cooking chamber opening formed by the outer walls 30, 42, 44, 46 at each end of the oven 10, respectively, leaving a predetermined opening at the entrance inlet or exit outlet 26A, 28A to accommodate the conveyor 22 and food carried on the conveyor 22. The end plugs 64, 68 can be manufactured and installed in a variety of ways. At each end 26, 28, there is an upper end plug 64 above the conveyor 22 and a lower end plug 68 below the conveyor 22. Each end plug 64, 68 can be constructed in the form of a wall panel or thick sheet having a wall area measured perpendicular to the conveyor longitudinal direction (for closing a corresponding area of the oven housing 12) and a thickness T (FIG. 6) measured perpendicular to the wall area. The thickness can be over 20 mm, and in some constructions over 25 mm. The end plugs 64, 68 can be partially or completely filled with thermal insulation material.

As shown in FIGS. 5A and 5B, lateral edges of the lower end plugs 68 can have reduced thickness and extend laterally outward to form flanges 69 for overlapping and contacting respective edges or ends of the front and rear walls 30, 42. Likewise, a lower edge 72 of each lower end plug 68 can include a portion or flange 70 that overlaps with an edge or end of the bottom wall 46. Thus, the lower end plugs 68 are sized and shaped to interfere with the adjacent housing outer walls so as to prevent full insertion therein—although a central portion of the lower end plugs 68 is configured to be received into the oven chamber. As shown best in FIG. 6, the lower edge 72 of each of the end plugs 68 has a plurality of edge sections, including a lowermost portion 73, a vertical abutment portion 74 adjacent the lowermost portion 73, a ledge portion 75, and a taper or chamfer portion 76. Each of these portions extends into the page in FIG. 6 to form a surface. The chamfer portion or chamfer surface 76 extends between the ledge portion 75 and an inner wall surface 78 of the end plug 68. The inner wall surface 78 can be a vertical wall (e.g., at a right angle with the ledge portion 75) and can face inwardly into the oven chamber 24. The inner wall surface 78 can form the innermost extent of the end plug 68, below the upper edge 80.

Opposite the lower edge 72, each of the lower end plugs 68 includes an upper edge 80. The lower and upper edges 72, 80 are spaced apart to define a height that corresponds to a height between a top surface of the bottom wall 46 and a bottom of the conveyor 22—particularly a bottom surface of the conveyor perimeter frame element 50 of the conveyor frame 34. When assembled into the closed position as shown in FIGS. 5A and 5B, the upper edge 80 of each end plug 68 is received within a pocket 84. The pocket 84 opens in the downward direction. The pocket 84 is formed in part by the conveyor 22 and in part by one or more exterior walls of the oven housing 12. For example, the pocket 84 can be formed by the front and/or rear walls 30, 42 in combination with multiple surfaces of the conveyor frame 34 (e.g., a bottom surface of the perimeter frame element 50 and an inner, oven chamber-facing surface of one or both of the channel 54 and the skid bars 60). A portion of the pocket 84 can be provided to abut or restrain the inner wall surface 78 of the end plug 68. For example, the end of the support member 40 can form part of the pocket 84. On the other hand, the pocket 84 may also be considered to extend further laterally outward where the lateral flanges 69 of the end plug 68 overlap with and abut against a main portion of the outer wall, particularly the front and rear walls 30, 42. For each lower end plug 68, there may be multiple pockets formed at multiple locations along the oven width, or a continuous widthwise pocket. In either case, the upper edge 80 of the end plug 68 is constrained against vertically upward movement and against longitudinal movement in either direction by the pocket 84 when the end plug 68 is positioned in the closed position such that the upper edge 80 is in the pocket 84. The pocket 84 provides horizontal clearance with respect to the thickness T. However, the clearance is small enough that the pocket 84 prevents the full retraction of the lower end plug 68 by straight horizontal movement thereof.

When in the closed position, each end plug 68 can further be secured to the oven housing 12 in any suitable manner. For example, the end plugs 68 are secured using fasteners such as conventional screws, bayonet-style, twist-to-lock fasteners, or other known fasteners. The front and rear walls 30, 42 can be provided with studs 90 that are received through openings 92 formed in the laterally outboard portions of the end plug 68. The openings 92 can be vertically-elongated slots. Vertical elongation in the openings 92 can accommodate and facilitate the assembly and disassembly movements of the end plugs 68, which can include multiple vertical positionings with respect to the oven housing 12. An additional amount of clearance to the studs 90 can be provided in the vertical direction as compared to the horizontal direction, since the horizontal positioning of the end plugs 68 is relatively constant throughout the assembly and disassembly movements. A corresponding retaining member 94 such as a cap, threaded nut, etc. engages each of the studs 90 to secure the end plug 68 against the ends of the front wall 30, the rear wall 42, and the bottom wall 46 to close the gaps therebetween and minimize heat leakage from the oven chamber 24 to the outside.

In the closed position of the lower end plugs 68 as shown in FIGS. 5A and 5B, the end plug 68 can be supported vertically by contact between the top surface of the bottom wall 46 and the ledge portion 75 of the lower edge 72. The lowermost portion 73 of the lower edge 72 and the adjacent vertical abutment portion 74 are situated outside the oven chamber 24 when the end plug 68 is supported in the closed position on the oven housing 12. The chamfer surface 76 can be situated inside the oven chamber 24, e.g., entirely therein. Likewise, the inner wall surface 78 of each lower end plug 68 can be situated inside the oven chamber 24. The lower end plugs 68, via the chamfer surface 76 and the inner wall surface 78, can form an end boundary of the oven chamber 24. The lower edge 72 of the lower end plug 68 begins at the chamfer surface 76. In a downward direction from the upper portion of the chamfer surface 76, the thickness of the end plug 68 decreases from the thickness T, which is the maximum or nominal thickness. The thickness can decrease along the chamfer surface 76 in a continuous manner, either uniformly as shown or non-uniformly. The chamfer surface 76 can be a straight flat surface (i.e., linear when viewed on edge as in FIG. 6). In other constructions, the chamfer surface 76 can have a curved profile, for example convex or concave, and the profile can be simple or complex. For the sake of brevity, use of the term “chamfer” shall include within its scope, without limitation, rounded and otherwise curved surfaces in addition to various straight surface chamfers. One example of a rounded or curved chamfer surface 76 is illustrated by the broken line at the bottom of FIG. 6.

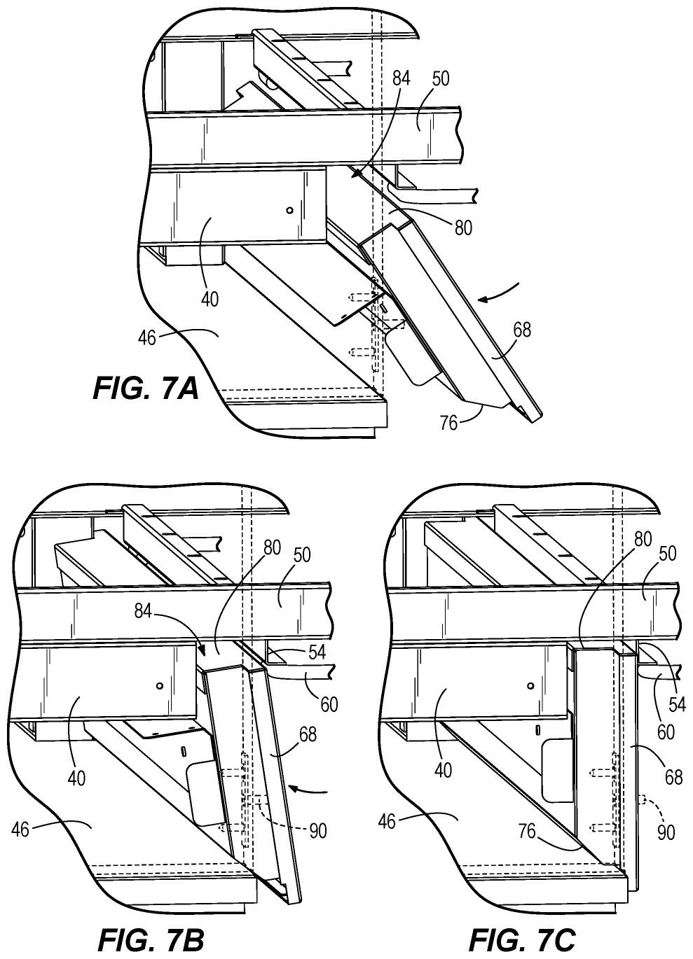

Although the chamfer surface 76 is illustrated as a 45-degree chamfer between the inner wall surface 78 and the ledge portion 75, the chamfer surface 76 can be oriented at a smaller or larger angle with respect to the inner wall surface 78. As will be appreciated further by the description below and FIGS. 7A to 7C, the chamfer surface 76 is an elongated or exaggerated chamfer between the inner wall surface 78 and the ledge portion 75, rather than simply a manufacturing necessity to avoid a sharp edge. For example, the chamfer surface 76 can have a length L (FIG. 6) between the inner wall surface 78 and the ledge portion 75, wherein the length L is over 15 mm. For example, the chamfer surface length L can be 20 mm or more. The chamfer surface 76 may also be referred to as a bevel or a corner-relief where the chamfer surface 76 connects the two adjacent (e.g., right-angled) surfaces of the ledge portion 75 and the inner wall surface 78, instead of a configuration in which the two adjacent surfaces of ledge portion 75 and inner wall surface 78 directly join to form a corner. The chamfer surface 76 can have a configuration (e.g., a combination of angle and length) that provides assembly clearance with the end of the bottom wall 46 that would otherwise not exist if the ledge portion 75 and the inner wall surface 78 extended directly join to form a corner.

The assembly method for installing the lower end plug 68 to the closed position is illustrated in FIGS. 7A to 7C. It will be appreciated that the disassembly method for removing the end plug 68 from its closed position is effectively illustrated by taking FIGS. 7A to 7C in reverse order. As noted above, the pocket 84 is provided for receiving the upper edge 80 of the lower end plug 68 in the closed position, and the pocket 84 is at least partially provided by the conveyor frame 34. The assembly of the lower end plug 68 into the closed position, and the disassembly to release it, can be accomplished while the conveyor frame 34 remains in its designated and fixed assembly position with respect to the oven housing 12. In other words, it is not necessary to move or disassemble the conveyor 22 to install or remove the lower end plugs 68 according to the present disclosure. The assembly process starts by a user grasping the end plug 68 and placing its upper edge 80 into the pocket 84 with the end plug 68 angled such that its lower edge 72 is further from the oven housing 12. As mentioned above, the pocket 84 provides horizontal clearance with respect to the thickness T of the end plug 68 (and also vertical clearance for the end plug height between the pocket 84 and the bottom wall 46) in order to enable the angled placement of the upper edge 80 therein. The user then pivots the lower edge 72 of the end plug 68 inward toward the oven chamber 24 while the upper edge 80 remains in the pocket 84. Although there may not be a strict singular pivot “point” for the end plug 68, the end plug 68 is generally pivoted at the engagement between the upper edge 80 and the pocket 84. The chamfer surface 76 can provide clearance between the bottom wall 46 and the lower edge 72 of the lower end plug 68 during pivoting. For example, the chamfer surface 76 can avoid a physical interference that would otherwise occur between the bottom wall 46 and the lower edge 72 during pivoting. In some constructions, or in some methods, the chamfer surface 76 can contact the bottom wall 46 and act to cam the end plug 68 upward and into the closed position. In particular, the end plug 68 can be cammed upward into the pocket 84 by contact with the bottom wall 46, for example as a horizontal assembly force is applied to the end plug 68. If adequate clearance is provided, the camming contact may be optional at the user's discretion. In other constructions, camming contact may be required during pivoting of the end plug 68 into and out of the closed position.

The foregoing detailed description of the certain exemplary embodiments has been provided for the purpose of explaining the principles of the application and examples of practical implementation, thereby enabling others skilled in the art to understand the disclosure for various embodiments and with various modifications as are suited to the particular use contemplated. This description is not necessarily intended to be exhaustive or to limit the application to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

What is claimed is:

1. A conveyor oven for cooking food, the conveyor oven comprising:
an oven housing defining an oven chamber in which the food is cooked;
a conveyor operable to convey the food through the oven chamber; and
an opening defined in an end of the oven chamber, wherein a portion of the conveyor extends through a first portion of the opening, and a second portion of the opening below the conveyor is closed by a removable end plug,
wherein the removable end plug is configured to pivot into a closed position while an upper edge of the removable end plug is received in a pocket formed at the end of the oven chamber by the oven housing and/or at least one stationary portion of the conveyor.

2. The conveyor oven of claim 1, wherein the at least one stationary portion of the conveyor forms a portion of the pocket and includes multiple portions of a weldment of a projecting frame portion of the conveyor outside a longitudinal end of the oven housing.

3. The conveyor oven of claim 2, wherein an inboard side of the pocket is formed at least in part by an end of a longitudinally extending support member secured on an interior side of an outer wall to support the conveyor.

4. The conveyor oven of claim 1, wherein the at least one stationary portion of the conveyor includes a longitudinal conveyor frame member that extends inside and outside the oven chamber, and one or both of:
a channel that depends downwardly from the longitudinal conveyor frame member and configured to support a crumb pan, and
a skid bar that extends along an underside of the longitudinal conveyor frame member outside the oven chamber, and
wherein the pocket is formed in part by each of: an outer edge of an exterior wall of the oven housing, the longitudinal conveyor frame member, and the channel and/or skid bar.

5. The conveyor oven of claim 1, wherein a lower edge of the removable end plug includes an oblique chamfer surface that faces into the oven chamber in the closed position, the chamfer surface having an angle and a length that provides clearance between the lower edge of the removable end plug and a bottom wall of the oven housing to permit the end plug to be pivoted into the closed position with the upper edge received in the pocket.

6. The conveyor oven of claim 5, wherein the chamfer surface is a straight chamfer surface, angled at 45 degrees from each of a pair of surfaces meeting at the chamfer surface.

7. The conveyor oven of claim 5, wherein a bottom portion of the chamfer surface terminates at a flat horizontal ledge portion of the removable end plug configured to rest on top of the bottom wall of the oven housing.

8. The conveyor oven of claim 7, wherein the lower edge of the removable end plug includes the ledge portion, the chamfer surface, and a portion configured to abut an outside surface of the bottom wall of the oven housing.

9. A conveyor oven for cooking food, the conveyor oven comprising:
an oven housing defining an oven chamber in which the food is cooked;
a conveyor operable to convey the food through the oven chamber, wherein the conveyor includes a frame and a track movable with respect to the frame; and
an opening defined in an end of the oven chamber, wherein a projecting portion of the conveyor extends out of the oven chamber through a first portion of the opening, and a second portion of the opening below the conveyor is closed by a removable end plug,
wherein, in a closed position of the removable end plug, an upper edge of the removable end plug is at least partially retained by a portion of the conveyor frame extending along the projecting portion of the conveyor, and
wherein when the removable end plug is in the closed position, a chamfer surface on a lower-inner corner of the removable end plug is received within the oven chamber adjacent a bottom wall of the oven housing.

10. The conveyor oven of claim 9, wherein the upper edge of the removable end plug is received in a pocket formed in part by each of: an outer edge of an outer wall of the oven housing, a longitudinal member of the conveyor frame that extends inside and outside the oven chamber, and one or both of:
a channel that depends downwardly from the longitudinal conveyor frame member to support a crumb pan, and
a skid bar that extends along an underside of the longitudinal conveyor frame member outside the oven chamber.

11. The conveyor oven of claim 10, wherein the chamfer surface has an angle and a length that provides clearance between a lower edge of the removable end plug and the bottom wall of the oven housing to permit the removable end plug to be pivoted into the closed position with the upper edge received in the pocket.

12. The conveyor oven of claim 10, wherein the pocket is formed in part by both of: the channel, and the skid bar.

13. The conveyor oven of claim 10, wherein the outer edge of the outer wall of the oven housing forming an inboard side of the pocket includes an end of a longitudinally extending support member secured on an interior side of the outer wall to support the conveyor.

14. The conveyor oven of claim 9, wherein a bottom portion of the chamfer surface terminates at a flat horizontal ledge portion that rests on top of the bottom wall of the oven housing in the closed position of the removable end plug.

15. The conveyor oven of claim 14, wherein a lower edge of the removable end plug includes the ledge portion, the chamfer surface, and a portion configured to abut an outside surface of the bottom wall of the oven housing.

16. The conveyor oven of claim 9, wherein the chamfered surface is a straight chamfer surface, angled at 45 degrees from each of a pair of surfaces meeting at the chamfer surface.

17. A method of assembling a conveyor oven for cooking food, wherein the conveyor oven includes an oven housing having an oven chamber in which food is cooked and a conveyor that extends through the oven chamber, the method comprising:
inserting an upper edge of a removable end plug into a pocket formed by the oven housing and a frame of the conveyor; and
moving the end plug into a closed position whereby at least a portion of a lower edge of the end plug is received inside the oven chamber along a bottom wall of the oven housing,
wherein contact that occurs between the lower edge of the end plug and the bottom wall of the oven housing during the movement of the end plug into the closed position cams the end plug further into the pocket.

18. The conveyor oven of claim 17, wherein the conveyor, including the frame thereof, remains secured in an operational assembly position during the inserting and moving steps.

19. The conveyor oven of claim 17, wherein the movement of the end plug into the closed position includes pivoting the end plug about the upper edge thereof.

20. The conveyor oven of claim 17, further comprising securing the removable end plug to the oven housing with at least one fastener.
